(19) United States
(12) Patent Application Publication
(10) Pub. No.: US 2008/0192351 A1
(43) Pub. Date: Aug. 14, 2008

(54) Antistatic Antireflection Film Free From Occurrence Of Interference Fringes

(75) Inventors: Sachiko Miyagawa, Tokyo-To (JP); Seiji Shinohara, Tokyo-To (JP); Toshio Yoshihara, Tokyo-To (JP)

Correspondence Address: BURR & BROWN, PO BOX 7068, SYRACUSE, NY, 13261-7068, US

(73) Assignee: Dai Nippon Printing Co., LTd, Tokyo-to (JP)

(21) Appl. No.: 10/594,691

(22) PCT Filed: Mar. 8, 2005
(86) PCT No.: PCT/JP2005/003989

§ 371 Date: Nov. 2, 2007

(30) Foreign Application Priority Data
Mar. 31, 2004 (JP) 2004-108378

(51) Int. Cl. G02B 1/11

(52) U.S. Cl. 359/586

(57) ABSTRACT

There is provided an antireflection film that can prevent the occurrence of interference fringes and, at the same time, has antistatic properties and excellent coating film adhesion. The first antireflection film comprises a transparent base material film 1 and, provided on the transparent base material film in the following order, an antistatic hardcoat layer 2-1 comprising an antistatic agent selected from polymeric antistatic agents, crosslinking group-containing low-molecular antistatic agents, and electrically conductive antistatic agents and having hard properties, and a low-refractive index layer 3 having a lower refractive index than an underlying layer in direct contact with the low-refractive index layer. The occurrence of interference fringes can be prevented by bringing the absolute value of the difference in refractive index between the transparent base material film 1 and the antistatic hardcoat layer 2-1 to not more than 0.03.

### BACKGROUND OF THE INVENTION

1. Field of Invention

The present invention relates to an antireflection film that is free from the occurrence of interference fringes and, at the same time, is free from the adherence of dust by virtue of its antistatic properties, has excellent coating film adhesion, and is usable on the surface of optical articles, for example, displays such as liquid crystal displays and plasma displays.

2. Background Art

Display surfaces of optical articles such as liquid crystal displays and plasma displays are required to cause no significant reflection of light applied from external light sources such as fluorescent lamps, from the viewpoint of enhancing visibility. In order to prevent the reflection, an antireflection film comprising a low-refractive index layer, with a lower refractive index than the refractive index of the underlying layer, provided on a transparent base material film either directly or through other layer has been applied to the surface of an optical article. Further, imparting hard properties to an antireflection film has also been carried out, because damage to the surface of an optical article deteriorates the visibility. Optical articles formed of plastics are electrically insulative, and, hence, the adherence of dust on the surface as a result of electrification by static electricity or the like deteriorates the visibility. Accordingly, imparting antistatic properties to optical articles has been required.

Regarding the antireflection film with antistatic properties and hard properties imparted thereto, an antistatic antireflection film comprising a transparent base material film, a metal oxide-containing antistatic layer provided on the transparent base material film, a hardcoat layer provided on the antistatic layer, and a low-refractive index layer as the uppermost layer having a lower refractive index than the underlying layer is known, for example, from Japanese Patent Laid-Open No. 255403/2001 (patent document 1). Further, antistatic antireflection films comprising a transparent base material film and a metal oxide-containing antistatic hardcoat layer provided on the transparent base material film is known from Japanese Patent Laid-Open No. 301018/2003 (patent document 2) and Japanese Patent Laid-Open No. 3751/2002 (patent document 26).

An antireflection film comprising a low-refractive index layer stacked on an organic antistatic hardcoat is known from Japanese Patent Laid-Open No. 256053/2002 (patent document 27).

[Patent document 1] Japanese Patent Laid-Open No. 255403/2001

[Patent document 2] Japanese Patent Laid-Open No. 301018/2003

[Patent document 3] Japanese Patent Publication No. 23828/1974

[Patent document 4] Japanese Patent Publication No. 23827/1974

[Patent document 5] Japanese Patent Publication No. 28937/1972

[Patent document 6] Japanese Patent Laid-Open No. 41695/1995

[Patent document 7] Japanese Patent Publication No. 734/1980

[Patent document 8] Japanese Patent Laid-Open No. 54672/1975

[Patent document 9] Japanese Patent Laid-Open No. 14735/1984

[Patent document 10] Japanese Patent Laid-Open No. 18175/1982

[Patent document 11] Japanese Patent Laid-Open No. 18176/1982

[Patent document 12] Japanese Patent Laid-Open No. 56059/1982

[Patent document 13] Japanese Patent Publication No. 13223/1978

[Patent document 14] Japanese Patent Publication No. 15376/1982

[Patent document 15] Japanese Patent Publication No. 45231/1978

[Patent document 16] Japanese Patent Publication No. 145783/1980

[Patent document 17] Japanese Patent Publication No. 65950/1980

[Patent document 18] Japanese Patent Publication No. 67746/1980

[Patent document 19] Japanese Patent Publication No. 11342/1982

[Patent document 20] Japanese Patent Publication No. 19735/1982

[Patent document 21] Japanese Patent Publication No. 56858/1983

[Patent document 22] Japanese Patent Laid-Open No. 27853/1986

[Patent document 23] Japanese Patent Laid-Open No. 9346/1987

[Patent document 24] Japanese Patent Laid-Open No. 279833/1998

[Patent document 25] Japanese Patent Laid-Open No. 80169/2000

[Patent document 26] Japanese Patent Laid-Open No. 3751/2002

[Patent document 27] Japanese Patent Laid-Open No. 256053/2002

### SUMMARY OF THE INVENTION

The antireflection films described in patent documents 1 and 2 comprise an antistatic layer which uses a metal oxide as an antistatic material from the viewpoint of preventing a deterioration in visual field caused by the adherence of dust on the surface of displays. Since metal oxides generally have a higher refractive index than a binder resin, an antistatic layer with a metal oxide added thereto has a higher refractive index than the base material film or the hardcoat layer and, thus, a refractive index difference occurs between the base material film and the antistatic layer or between the hardcoat layer and the antistatic layer. The refractive index difference poses a problem that interference fringes, which deteriorate the visibility of optical articles such as displays, occur.

For example, in an example of an antireflection film comprising a conventional general antistatic layer, a triacetylcellulose film (a transparent base material film) has a refractive index of about 1.5, a metal oxide-containing antistatic layer has a refractive index of about 1.57 to 1.60, and the hardcoat layer has a refractive index of about 1.50. This great difference in refractive index between layers in contact with each other causes a problem that external light which entered from surface side is reflected from the interface of the transparent base material film and the antistatic layer and the interface of the antistatic layer and the hardcoat layer and the reflected lights cause interferences which are sometimes observed as uneven interference (color shading).

From the viewpoint of preventing the occurrence of interference fringes derived from the refractive index difference, the use, as an antistatic agent, of a surfactant of which the refractive index is not higher than that of the metal oxide is considered effective. The surfactant, however, suffers from a problem that the surfactant is likely to bleed out and, consequently, the adhesion to other layer is likely to be lowered. Another problem is that the humidity dependence is high and the water resistance is poor.

The present invention provides an antireflection film that can prevent the occurrence of interference fringes and, at the same time, has antistatic properties, has excellent coating film adhesion, and has good transparency of the coating film after a high-temperature and high-humidity test.

A first antireflection film according to the present invention, characterized by comprising: a transparent base material film and, provided on the transparent base material film in the following order, an antistatic hardcoat layer comprising an antistatic agent and an ionizing radiation curing resin, the antistatic agent being selected from polymeric antistatic agents, crosslinking group-containing low-molecular antistatic agents, and electrically conductive antistatic agents, and a low-refractive index layer having a lower refractive index than an underlying layer in direct contact with the low-refractive index layer, the absolute value of the difference in refractive index between the transparent base material film and the antistatic hardcoat layer being not more than 0.03, whereby the occurrence of interference fringes is prevented.

In the first antireflection film according to the present invention, antistatic properties are imparted to the hardcoat layer. Alternatively, two functions, that is, antistatic properties and hard properties, may be imparted to respective separate layers. Specifically, according to the present invention, there is provided a second antireflection film characterized by comprising: a transparent base material film and, provided on the transparent base material film in the following order, an antistatic layer comprising an antistatic agent and a binder resin, said antistatic agent being selected from polymeric antistatic agents, crosslinking group-containing low-molecular antistatic agents, and electrically conductive antistatic agents, a hardcoat layer comprising an ionizing radiation curing resin, and a low-refractive index layer having a lower refractive index than an underlying layer in direct contact with the low-refractive index layer, both the absolute value of the difference in refractive index between the transparent base material film and the antistatic layer and the absolute value of the difference in refractive index between the antistatic layer and the hardcoat layer being not more than 0.03, whereby the occurrence of interference fringes is prevented.

In the antistatic hardcoat layer or the antistatic layer in the antireflection film according to the present invention, since an organic antistatic material having a lower refractive index than the metal oxide is used, the absolute value of the difference in refractive index between the transparent base material film and the antistatic layer can be regulated to not more than 0.03, and, the absolute value of the difference in refractive index between the antistatic layer and the hardcoat layer can be regulated to not more than 0.03.

Since the antireflection film according to the present invention comprises an antistatic layer containing a reactive group introduced-type or salt introduced-type polymeric antistatic material or an electrically conductive polymeric antistatic material, the absolute value of the difference in refractive index between the transparent base material film and the antistatic hardcoat layer or the antistatic layer can be brought to not more than 0.03 and, further, the absolute value of the difference in refractive index between the antistatic layer and the hardcoat layer can be brought to not more than 0.03, whereby the occurrence of interference fringes at the interface of the transparent base material film and the antistatic hardcoat layer or the antistatic layer or the occurrence of interference fringes at the interface of the antistatic layer and the hardcoat layer can be prevented.

### BRIEF DESCRIPTION OF THE DRAWINGS

FIG. 1 is a schematic cross-sectional view showing the layer construction of an antireflection film in the first embodiment of the present invention.

FIG. 2 is a schematic cross-sectional view showing the layer construction of an antireflection film in the second embodiment of the present invention.

### DESCRIPTION OF REFERENCE CHARACTERS

1 transparent base material film
2-1 antistatic hardcoat layer
2-2 antistatic layer
2-3 hardcoat layer
3 low-refractive index layer

### BEST MODE FOR CARRYING OUT THE INVENTION

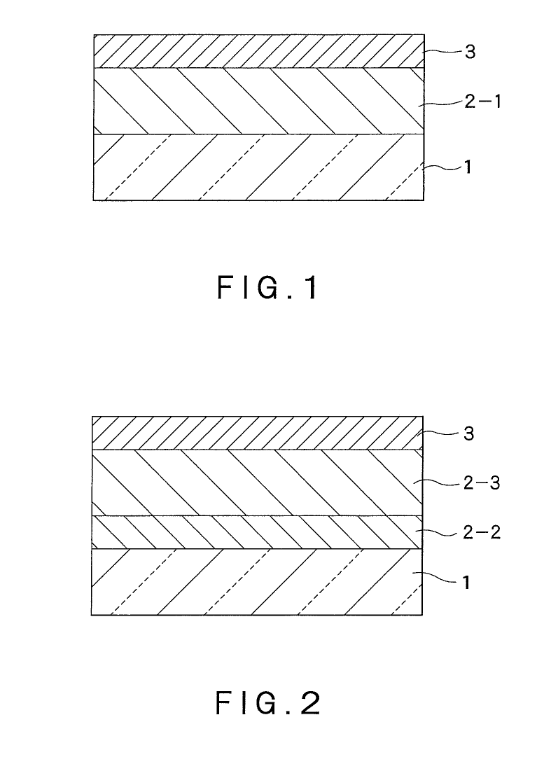

FIG. 1 is a schematic cross-sectional view showing the layer construction of an antireflection film in the first embodiment of the present invention. In the antireflection film shown in FIG. 1, an antistatic hardcoat layer 2-1 is provided on a transparent base material film 1, and a low-refractive index layer 3 is further provided on the antistatic hardcoat layer 2-1.

FIG. 2 is a schematic cross-sectional view showing the layer construction of an antireflection film in the second embodiment of the present invention. In the antireflection film shown in FIG. 2, a layer for imparting hard properties and a layer for imparting antistatic properties are provided in two respective separate layers. Specifically, an antistatic layer 2-2 is provided on a transparent base material film 1, a hardcoat layer 2-3 is provided on the antistatic layer 2-2, and a low-refractive index layer 3 is further provided on the hardcoat layer 2-3.

Antistatic Hardcoat Layer/Antistatic Layer

The antistatic hardcoat layer or antistatic layer in the antireflection film according to the present invention should have a surface resistivity of not more than 1.0×10¹³Ω/□ from the viewpoint of preventing dust adherence. When the surface resistivity is 1.0×10¹³Ω/□ to 1.0×10¹²Ω/□, electrostatic charges are not accumulated although the antireflection film is electrified. Accordingly, in this case, the prevention of dust adherence to the film and the like can be achieved. Preferably, the surface resistivity is in such a range that, although electrification to generate electrostatic charges occurs, the generated electrostatic charges are immediately attenuated, that is, in the range of 1.0×10¹²Ω/□ to 1.0×10¹⁰Ω/□, more preferably in such a range that electrification does not occur, that is, not more than 1.0×10¹⁰Ω/□, most preferably not more than 1.0×10⁸Ω/□.

A method by which the organic antistatic agent has hitherto been most commonly used is that a low-molecular surfactant is added to the coating composition for antistatic layer formation followed by the formation of a coating film as an antistatic layer, or that a surfactant is coated onto the surface. The low-molecular surfactant, however, has the following drawbacks. The antistatic agent comes off from the film upon washing with water, wipe off cleaning or the like, and, consequently, the antistatic effect is not persistent. Bleedout of the antistatic agent causes blocking or the like, leading to deteriorated surface properties. Most of low-molecular surfactants have poor heat resistance and are likely to be decomposed during molding, and, further, concentrate on the interface of the coating film and consequently deteriorates the adhesion of the coating film, often leading to the separation. For the above reasons, the low-molecular surfactant is not used in the present invention.

1) Antistatic Agent

Antistatic agents usable in the antistatic hardcoat layer or antistatic layer in the antireflection film according to the present invention include polymeric antistatic agents, crosslinking group-containing low-molecular antistatic agents, and electrically conductive antistatic agents. In the coating composition for the formation of the antistatic hardcoat layer or antistatic layer in the antireflection film according to the present invention, any of these antistatic agents has been added to the ionizing radiation curing resin.

Polymeric antistatic agents include anionic polymer compounds as disclosed, for example, in Japanese Patent Publication No. 23828/1974 (patent document 3), Japanese Patent Publication No. 23827/1974 (patent document 4), Japanese Patent Publication No. 28937/1972 (patent document 5), and Japanese Patent Laid-Open No. 41695/1995 (patent document 3); ionene polymers having a dissociation group in the main chain as disclosed, for example, in Japanese Patent Publication No. 734/1980 (patent document 7), Japanese Patent Laid-Open No. 54672/1975 (patent document 8), Japanese Patent Laid-Open No. 14735/1984 (patent document 9), Japanese Patent Laid-Open No. 18175/1982 (patent document 10), Japanese Patent Laid-Open No. 18176/1982 (patent document 11), Japanese Patent Laid-Open No. 56059/1982 (patent document 12); and cationic polymer compounds as disclosed, for example, in Japanese Patent Publication No. 13223/1978 (patent document 13), Japanese Patent Publication No. 15376/1982 (patent document 14), Japanese Patent Publication No. 45231/1978 (patent document 15), Japanese Patent Publication No. 145783/1980 (patent document 16), Japanese Patent Publication No. 65950/1980 (patent document 17), Japanese Patent Publication No. 67746/1980 (patent document 18), Japanese Patent Publication No. 11342/1982 (patent document 19), Japanese Patent Publication No. 19735/1982 (patent document 20), Japanese Patent Publication No. 56858/1983 (patent document 21), Japanese Patent Laid-Open No. 27853/1986 (patent document 22), Japanese Patent Laid-Open No. 9346/1987 (patent document 23), Japanese Patent Laid-Open No. 279833/1998 (patent document 24), and Japanese Patent Laid-Open No. 80169/2000 (patent document 25). Particularly preferred polymeric antistatic agents are compounds containing a molecular crosslinking group among the above polymeric antistatic agents. Quaternary ammonium cation-containing structures are most preferred for use in an impact-resistant layer in the antireflection film. Quaternary ammonium antistatic agents are also preferred because adhesion to adjacent other layer (recoating properties) can be improved and, further, the suppression of a lowering in transparency after the high temperature and high humidity resistance test can be maximized.

Structures of the quaternary ammonium salt contained in the polymeric antistatic agent include, but are not limited to, the following structures.

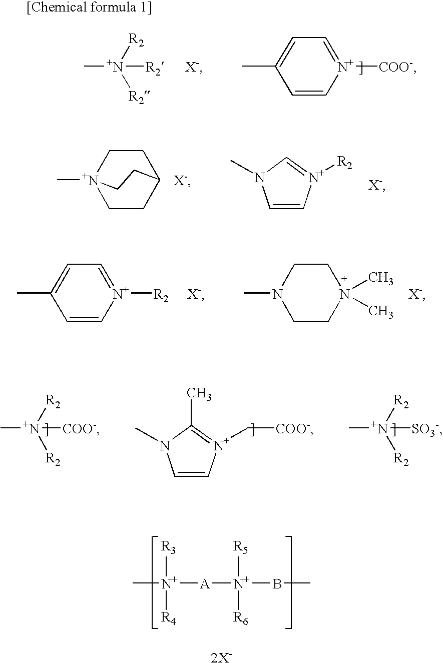

wherein R₂, R₂′ and R₂″ represent an alkyl chain;

X⁻ represents anion, for example, Cl⁻, Br⁻, I—, F—, HSO⁴SO₄²⁻, NO₃⁻, PO₄³⁻, HPO₄²⁻, H₂PO₄⁻, C₆H₅, SO₃⁻, or OH⁻;

R₃, R₄, R₅ and R₆ represent a substituted or unsubstituted alkyl group having 1 to 4 carbon atoms, and R₃ and R₄ and/or R₅ and R₆ may combine together to form a nitrogen-containing heterocyclic ring such as piperazine;

A, B and D each represent a substituted or unsubstituted alkylene, arylene, alkenylene, or arylenealkylene group having 2 to 10 carbon atoms, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂— or —R₂₅NHCONHR₂₄NHCONHR₂₅— wherein R₇, R₈, R₉, R₁₁, R₁₂, R₁₄, R₁₅, R₁₆, R₁₇, R₁₉, R₂₀, R₂₂, R₂₃ and R₂₅ represent an alkylene group, and R₁₀, R₁₃, R₁₈, R₂₁ and R₂₄ each represent a linking group selected from the group consisting of substituted or unsubstituted alkylene, alkenylene, arylene, arylenealkylene, and alkylenearylene groups;

m is a positive integer of 1 to 4; and

X⁻ represents an anion.

Specific examples of polymer compounds containing a quaternary ammonium salt are as follows. However, the present invention is not limited to these examples only.

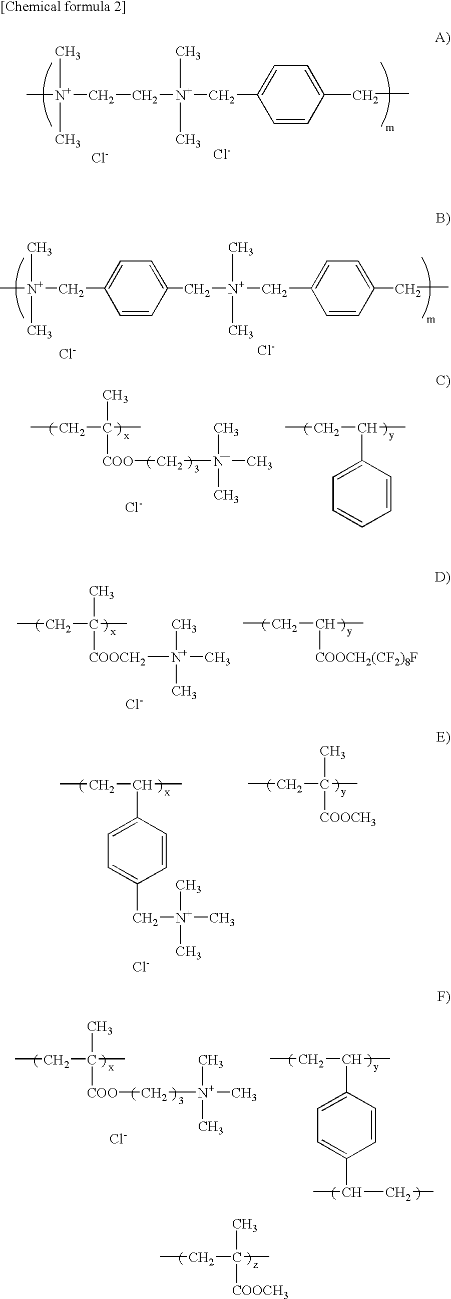

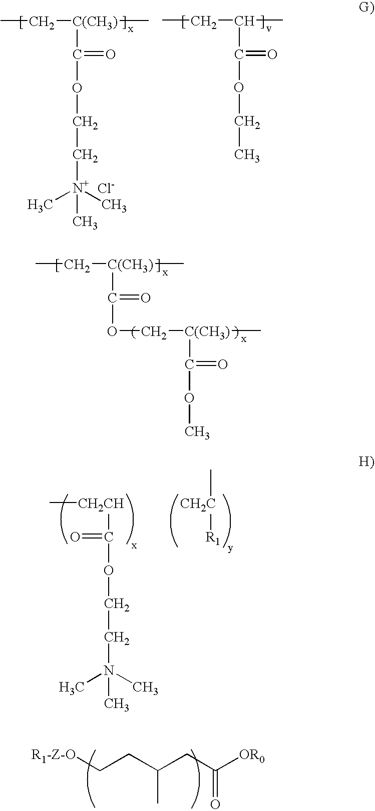

The value of x in the case where the polymeric antistatic agent contains a quaternary ammonium salt, may be 1 to 70% by mole. When the amount of the quaternary ammonium salt is less than 10% by mole, the antistatic property cannot be developed. On the other hand, when the amount of the quaternary ammonium salt is more than 70% by mole, the compatibility with the resin component is lowered. More preferably, the amount of the quaternary ammonium salt is 3 to 50% by mole.

The polymeric antistatic agent can provide a permanent antielectric resin which is superior in effect persistence to the low-molecular surfactant and, at the same time, can prevent bleedout of the antistatic agent. Accordingly, when the low-refractive index layer is stacked on the top of the antistatic layer, an improvement in adhesion to the low-refractive index layer can be expected. The presence of a polymerizable functional group in one molecule of the compound constituting the antistatic agent is preferred, because, upon exposure of the antistatic agent to ultraviolet light or electron beams, the antistatic agent is chemically bonded to the ionizing radiation curing binder as the hardcoat component and consequently is fixed in the hardcoat, contributing to reduced bleedout of the antistatic agent and reduced coming-off of the antistatic agent upon washing with water, wipe off cleaning or the like.

In the low-molecular antistatic agent, the presence of a molecular crosslinking group in its molecule is preferred, because, upon exposure of the antistatic agent to ultraviolet light, the antistatic agent is chemically bonded to the ionizing radiation curing binder as the hardcoat component and consequently is fixed in the hardcoat, contributing to reduced bleedout of the antistatic agent and reduced coming-off of the antistatic agent upon washing with water, wipe off cleaning or the like. The molecular crosslinking group-containing low-molecular antistatic agent may be any of anionic, nonionic, or cationic compounds.

Electrically conductive antistatic agents include aliphatic conjugated polyacetylenes, aromatic conjugated poly(paraphenylenes), heterocyclic conjugated polypyrroles, polythiophene, heteroatom-containing conjugated polyanilines, and mixed type conjugated poly(phenylenevinylenes) may be mentioned. Further examples thereof include double-chain conjugated systems which are conjugated systems having a plurality of conjugated chains in the molecule thereof, and electrically conductive composites which are polymers prepared by grafting or block-copolymerizing the above conjugated polymer chain onto a saturated polymer. Since these electrically conductive antistatic agents are polymeric, they can provide permanent antielectric resins which are superior in effect persistence to the low-molecular surfactant. Further, in this case, the bleedout of the antistatic agent can be prevented, and, in stacking of the low-refractive index layer on the top of the antistatic layer, an improvement in adhesion to the low-refractive index layer can be improved.

2) Binder Resin

Monomers, oligomers, and polymers containing a polymerizable functional group that causes a reaction which allows the formation of a large molecule such as polymerization or dimerization to proceed either directly or indirectly through the action of an initiator upon exposure to an ionizing radiation, may be used as the ionizing radiation curing resin used as the binder resin in the antistatic hardcoat layer or antistatic layer. Specifically, radically polymerizable monomers and oligomers containing an ethylenically unsaturated bond such as an acryl group, a vinyl group, or an allyl group are preferred. From the viewpoint of causing a crosslinking bond between molecules in the binder component, the binder component is preferably a polyfunctional binder component containing two or more, preferably three or more, polymerizable functional groups in one molecule. However, other ionizing radiation curing binder components may also be used. For example, photocation polymerizable monomes and oligomers such as epoxy-containing compounds may be used. In order to improve the electric conductivity, EO- or other modified hydrophilic binders, which can improve ion conductivity, are preferred. Further, the use of a binder component having a residual hydroxyl group in its molecule is preferred. The hydroxyl group in the binder can improve the adhesion to adjacent layer such as the hardcoat layer or the low-refractive index layer by the hydrogen bond.

The following binder resin is preferably used from the viewpoint of adding the function of preventing curling.

Acrylic resins, polyester resins, polyolefin resins, polycarbonate resins, polyamide resins, polyether resins, epoxy resins, urethane resins, alkyd resins, spiroacetal resins, polybutadiene resins, polythiol polyether resins, polyhydric alcohols, (meth)acrylate resins such as ethylene glycol (meth)acrylate, and pentaerythritol (meth)acrylate monostearate are selected as the resin used in the case where the light transparent base material is triacetate cellulose (TAC).

Specifically, the modified pentaerythritol acrylate having a tetra- or higher functional group is selected from pentaerythritol triacrylate, pentaerythritol tetraacrylate, dipentaerythritol hexaacrylate, and their modification products.

The isocyanuric acid-modified or bisphenol-modified acrylate resin having a tri-or lower functional group is selected, for example, from modified isocyanuric acid EO-modified diacrylate, modified isocyanuric acid EO-modified triacrylate, bisphenol F EO-modified diacrylate, bisphenol A EO-modified diacrylate, and epoxy-modified bisphenol A diacrylate.

Acrylic resins, polyester resins, polyolefin resins, polycarbonate resins, polyamide resins, polyether resins, epoxy resins, urethane resins, alkyd resins, spiroacetal resins, polybutadiene resins, polythiol polyether resins, polyhydric alcohols, (meth)acrylate resins such as ethylene glycol (meth)acrylate, and pentaerythritol (meth)acrylate monostearate are selected as the resin used in the case where the light transparent base material is polyethylene terephthalate (PET).

Specifically, the modified pentaerythritol acrylate having a tetra- or higher functional group is selected from pentaerythritol triacrylate, pentaerythritol tetraacrylate, dipentaerythritol hexaacrylate, and their modification products.

The isocyanuric acid-modified or bisphenol-modified acrylate resin having a tri-or lower functional group is selected, for example, from modified isocyanuric acid EO-modified diacrylate, modified isocyanuric acid EO-modified triacrylate, bisphenol F EO-modified diacrylate, bisphenol A EO-modified diacrylate, and epoxy-modified bisphenol A diacrylate. The presence of at least one type of them in the binder resin suffices for contemplated effect.

When the binder resin is photocuring resin, the use of a photoinitiator is preferred for initiating the radical polymerization. The photoinitiator is not particularly limited, and examples thereof include acetophenones, benzophenones, ketals, anthraquinones, disulfide compounds, thiuram compounds, and fluoroamine compounds.

When the antistatic layer and the hardcoat layer are stacked as separate coating films as in the second antireflection film according to the present invention, no hard properties are required of the resin used in the antistatic layer. Accordingly, the resin is not limited to the ionizing radiation curing resin and preferably has adhesion to adjacent layer. When the antistatic layer and the hardcoat layer are stacked as separate coating films, the thickness of the antistatic layer may be smaller than the case where the antistatic hardcoat layer is formed.

3) Solvent

In the coating composition for antistatic hardcoat layer or antistatic layer formation, an organic solvent is indispensable for dissolving or dispersing the solid component. The type of the solvent is not particularly limited. Solvents usable herein include, for example, alcohols such as methanol, ethanol, and isopropyl alcohol; ketones such as methyl ethyl ketone, methyl isobutyl ketone, and cyclohexanone; esters such as ethyl acetate and butyl acetate; halogenated hydrocarbons; and aromatic hydrocarbons such as toluene and xylene. In order to prevent the occurrence of interference fringes, a solvent (penetrating solvent) which can penetrate into the light-transparent base material is preferably used or used in combination with other solvent. In the present invention, the term “penetrating” referred to in connection with the penetrating solvent include all of concepts such as penetrating properties, swelling properties, and wetting properties with respect to light transparent base materials. Specific examples of penetrating solvents include: alcohols such as isopropyl alcohol, methanol, and ethanol; ketones such as methyl ethyl ketone, methyl isobutyl ketone, and cyclohexanone; esters such as methyl acetate, ethyl acetate, and butyl acetate; halogenated hydrocarbons; aromatic hydrocarbons such as toluene and xylene; phenols; or mixtures thereof. Preferred are esters (more preferably methyl acetate).

Solvents used in the case where the light transparent base material is triacetate cellulose (TAC), include acetone, methyl acetate, ethyl acetate, butyl acetate, chloroform, methylene chloride, trichloroethane, tetrahydrofuran, methyl ethyl ketone, methylisobutyl ketone, cyclohexanone, nitromethane, 1,4-dioxane, dioxolane, N-methylpyrrolidone, N,N-dimethylformamide, methanol, ethanol, isopropyl alcohol, butanol, isobutyl alcohol, diisopropyl ether, methyl cellosolve, ethyl cellosolve, and butyl cellosolve.

Solvents used in the case where the light transparent base material is polyethylene terephthalate (PET), include phenol, chlorobenzene, nitrobenzene, chlorophenol, hexafluoroisopropanol, acetone, methyl acetate, ethyl acetate, butyl acetate, chloroform, methylene chloride, trichloroethane, tetrahydrofuran, methyl ethyl ketone, methylisobutyl ketone, cyclohexanone, nitromethane, 1,4-dioxane, dioxolane, N-methylpyrrolidone, N,N-dimethylformamide, methanol, ethanol, isopropyl alcohol, butanol, isobutyl alcohol, diisopropyl ether, methyl cellosolve, ethyl cellosolve, and butyl cellosolve.

For example, methyl acetate, ethyl acetate, butyl acetate, and methyl ethyl ketone are particularly suitable as the solvent used in the case where the light transparent base material is triacetate cellulose (TAC).

Phenol, chlorobenzene, nitrobenzene, chlorophenol, and hexafluoroisopropanol are particularly suitable as the solvent used in the case where the light transparent base material is polyethylene terephthalate (PET).

4) Other Components

If necessary, a polymerization initiator for the ionizing radiation curing binder component may be contained as a component other than the above components in the coating composition for antistatic hardcoat layer or antistatic layer formation. Other components may also be incorporated. For example, if necessary, ultraviolet shielding agents, ultraviolet absorbers, and surface conditioning agents (levelling agents) and the like may be used.

5) Preparation Method

The composition for antistatic hardcoat layer or antistatic layer formation may be one which has already been brought to an ink form, or alternatively may be prepared by combining the antistatic agent, the ionizing radiation curing binder, the photoinitiator, the solvent and the like. The coating composition for antistatic hardcoat layer or antistatic layer formation may be prepared using the above components by dispersion treatment according to a conventional preparation method for coating liquids. For example, a coating composition may be prepared by mixing the indispensable components and desired components in any order.

The coating composition for antistatic hardcoat layer or antistatic layer formation may be coated onto the base material by various methods, for example, spin coating, dip coating, spraying, slide coating, bar coating, roll coating, meniscus coating, flexographic printing, screen printing, or bead coating. In general, the coated base material is if necessary dried and is then exposed to an ionizing radiation such as ultraviolet light or electron beams to cure the coating and thus to form an antistatic layer.

Transparent Base Material Film

The material for the transparent base material film may be any material commonly used in the antireflection film without particular limitation and examples thereof include films formed of various resins, for example, cellulose triacetate (TAC), polyethylene terephthalate (PET), diacetyl cellulose, cellulose acetate butylate, polyethersulfone, acrylic resin, polyurethane resin, polyester, polycarbonate, polysulfone, polyether, trimethylpentene, polyether ketone, and (meth)acrylonitrile. The thickness of the base material is generally about 25 μm to 1000 μm.

Hardcoat Layer

When a layer for imparting antistatic properties and a layer for imparting hardcoat properties are formed as two separate coating layers, that is, when the antistatic layer and the hardcoat layer are formed as two separate coating layers as in the second antireflection film according to the present invention, the hardcoat layer may be a conventional hardcoat layer. The ionizing radiation curing resin used in the binder in the antistatic hardcoat layer which has been already described in detail may be used in the coating composition for hardcoat layer formation. The ionizing radiation curing resin imparts hard properties to the coating film.

Low-Refractive Index Layer

The low-refractive index layer stacked on the uppermost layer in the antireflection film according to the present invention may be formed by any commonly used conventional method for low-refractive index layer formation. The low-refractive index layer may be formed, for example, by forming a coating film using a coating liquid containing inorganic fine particles having a low refractive index such as silica or magnesium fluoride and a binder resin, or a coating liquid containing inorganic fine particles having a low refractive index such as void-containing silica or magnesium fluoride and a binder resin, or a coating liquid containing a fluororesin and the like, or by forming a thin film by vapor depositing inorganic fine particles having a low refractive index.

In the present invention, the expression “void-containing fine particles” refers to fine particles and aggregates thereof that, in the case where gas is air having a refractive index of 1.0, have a refractive index which is lowered inversely proportionally to the proportion of air in the fine particles, as compared with the refractive index of the fine particles per se, as a result that the particles have taken a structure comprising gas filled into fine particles and/or a gas-containing porous structure or fine particles have formed aggregates. Preferred void-containing fine particles include, for example, particles having an average particle diameter range usable in the present invention, among controlled release materials, which are produced for increasing the specific surface area and can realize adsorption of various chemical materials on a packing column or the porous part on the surface thereof, porous fine particles for use in catalyst fixation, and hollow fine particles to be incorporated into heat insulating materials and low-permittivity materials.

### EXAMPLES

### (1) Re: Examples 1 to 4 and Comparative Examples 1 to 3

Layer Construction I (Base Material/AS+HC/AR)

In the following Examples 1 to 3 and Comparative Examples 1 to 3, an antireflection film having a layer construction of transparent base material film/antistatic hardcoat layer/low-refractive index layer was prepared as follows.

A triacetylcellulose (TAC) film (TF-T80UZ: tradename, manufactured by Fuji Photo Film Co., Ltd., refractive index 1.49) was provided as a transparent base material film. A coating composition for antistatic hardcoat layer formation described in Examples 1 to 4 and Comparative Examples 1 to 3 was bar coated on the transparent base material film. The solvent was removed from the coating by drying, and the coating was then exposed to ultraviolet light at an exposure of 100 mJ/cm² with an ultraviolet irradiation device (manufactured by Fusion UV Systems Japan K.K.) to cure the coating and thus to form a hardcoat layer. Thus, a laminate film having a layer construction of transparent base material film/about 5 μm-thick antistatic hardcoat layer was prepared.

A coating composition for low-refractive index layer formation having the following composition was bar coated onto the laminate film of transparent base material film/antistatic hardcoat layer. The assembly was dried to remove the solvent from the coating, and the assembly was then exposed to ultraviolet light with an ultraviolet irradiation device (manufactured by Fusion UV Systems Japan K.K.) at an exposure of 260 mJ/cm² to cure the coating film. Thus, a laminate (antireflection film) having a layer construction of transparent base material film/antistatic hardcoat layer/about 100 nm-thick low-refractive index layer was prepared.

Formulation of Coating Composition for Low-Refractive Index Layer Formation

| | |
|---|---|
| Void-containing silica sol | 14.28 parts by mass |
| (manufactured by Catalysts and | |
| Chemicals Industries Co., Ltd., | |
| 20% isopropyl alcohol solution) | |
| pentaerythritol triacrylate (PETA) | 1.90 parts by mass |
| Irgacure 907 | 0.02 part by mass |
| (tradename, manufactured by | |
| Ciba Specialty Chemicals, K.K.) | |
| Irgacure 184 | 0.07 part by mass |
| (tradename, manufactured by | |
| Ciba Specialty Chemicals, K.K.) | |
| TSF4460 (tradename, | 0.24 part by mass |
| manufactured by GE Toshiba Silicones: | |
| alkyl polyether-modified silicone oil) | |
| methyl isobutyl ketone | 83.49 parts by mass |

The surface resistivity, the minimum reflectance, the refractive index of the low-refractive index layer, the refractive index of the transparent base material film, the occurrence of interference fringes, and the adhesion of the coating film were evaluated for the antireflection films prepared in Examples 1 to 4 and Comparative Examples 1 to 3 as follows.

Surface Resistivity (Ω/□)

The surface resistivity was measured for the outermost surface of the laminate with a high resistivity meter (Hiresta-HT-210, tradename, manufactured by Mitsubishi Petrochemical Co., Ltd.) under conditions of applied voltage 500 V and 10 sec.

Minimum Reflectance

The reflectance was measured with a spectrophotometer provided with a 5° regular reflection measuring device (manufactured by Shimadzu Seisakusho Ltd., UV-3100PC: tradename). The minimum value around the wavelength 550 nm was determined as the reflectance.

Refractive Index

Bar coating was carried out onto a triacetylcellulose film base material (FT-T80UZ: tradename, manufactured by Fuji Photo Film Co., Ltd., refractive index 1.49) to a film thickness of about 0.1 μm. The absolute reflectance was measured with a spectrophotometer (UV-3100PC) manufactured by Shimadzu Seisakusho Ltd. The thickness of the low-refractive index layer was set so that the minimum value of the reflectance is at a wavelength around 550 nm. The refractive index of the low-refractive index layer was determined from the reflectance curve by simulation.

Interference Fringes

The antireflection film was visually inspected with an interference fringe testing lamp (a Na lamp) manufactured by FUNATECH CO., LTD. for the occurrence of interference fringes. When interference fringes were not substantially observed, the occurrence of interference fringes was evaluated as good ◯; when interference fringes were obscurely observed, the occurrence of interference fringes was evaluated as fair Δ; and when interference fringes were clearly observed, the occurrence of interference fringes was evaluated as failure x.

Adhesion of Coating Film

The coating film adhesion test was carried out by a cross-cut peeling test described in JIS K 5400 in which 100 crosscuts were formed at intervals of 1 mm and the test was carried out using a cellophane tape (manufactured by Nichiban Co., Ltd.). In this evaluation method, the peel test was carried out five times while replacing the cellophane tape with a fresh one each time. After the separation, when not less than 90% of the 100 squares suffered from neither damage nor separation, the coating film adhesion was evaluated as ◯; when not less than 50% of the 100 squares suffered from neither damage nor separation, the coating film adhesion was evaluated as Δ; and when the proportion of the squares suffering from neither damage nor separation is less than 50%, the coating film adhesion was evaluated as x.

Transparency of Coating Film

Measurement of Haze Value

The haze value of the outermost surface of the anti-dazzling laminate was measured according to JIS K 7105: 1981 “Testing methods for optical properties of plastics.”

Environmental Test Under High Temperature and High Humidity Conditions

The coating sample was allowed to stand in a high-temperature/high humidity (80° C./90%) tank for 500 hr, and the haze and surface resistivity after standing for 500 hr were measured.

### Example 1

A coating composition of Example 1 as a coating composition for antistatic hardcoat layer formation was prepared by mixing the following ingredients together.
ASC-EX-9000 (tradename, manufactured by Kyoeisha Chemical Co., Ltd.; prepared as an ink for antistatic hardcoat and comprising
   i. quaternary ammonium salt-containing polymeric polymer, ii. ionizing radiation curing resin, and iii. hydrophilic acrylate oligomer, both components ii. and iii. containing a reactive group which is reacted upon UV curing) 75 parts by mass

| | |
|---|---|
| Methyl acetate | 25 parts by mass |

Physical properties were measured by the above methods for an antireflection film produced by the above process using this coating composition, and the results are shown in Table 1 below.

### Example 2

A coating composition of Example 2 as a coating composition for antistatic hardcoat layer formation was prepared by mixing the following ingredients together.

UV-1000NT5 (tradename, manufactured by Nippon Kasei Chemical Co., Ltd.;
a quaternary ammonium polymeric antistatic agent prepared as an ink for antistatic hardcoat 60 parts by mass Methyl ethyl ketone 30 parts by mass

Physical properties were measured by the above methods for an antireflection film produced by the above process using this coating composition, and the results are shown in Table 1 below.

### Example 3

A coating composition of Example 3 as a coating composition for antistatic hardcoat layer formation was prepared by mixing the following ingredients.

UT-3806 (tradename, manufactured by The Nippon Synthetic Chemical Industry Co., Ltd.; a quaternary ammonium polymeric antistatic agent prepared as an ink for antistatic hardcoat 75 parts by mass

| | |
|---|---|
| Methyl acetate | 25 parts by mass |

Physical properties were measured by the above methods for an antireflection film produced by the above process using this coating composition, and the results are shown in Table 1 below.

### Comparative Example 1

### Example Where no Antistatic Agent is Used

A coating composition of Comparative Example 1 as a coating composition for hardcoat layer formation was prepared by mixing the following ingredients.

| | |
|---|---|
| Pentaerythritol triacrylate (PETA) | 28.57 parts by mass |
| Irgacure 907 | 0.11 part by mass |
| (tradename, manufactured by | |
| Ciba Specialty Chemicals, K.K.) | |
| methyl isobutyl ketone | 83.26 parts by mass |

Physical properties were measured by the above methods for an antireflection film produced by the above process using this coating composition, and the results are shown in Table 1 below.

### Comparative Example 2

### Example Where Metal Oxide is Used as Antistatic Agent

A coating composition of Comparative Example 2 as a coating composition for antistatic hardcoat layer formation was prepared by mixing the following ingredients together.

| | |
|---|---|
| Tin indium oxide dispersion | 33.3 parts by mass |
| (solid content 30%, methyl isobutyl | |
| ketone solution) | |
| Pentaerythritol triacrylate (PETA) | 10.0 parts by mass |
| Irgacure 184 (tradename, manufactured | 0.05 part by mass |
| by Ciba Specialty Chemicals, K.K.) | |
| Methyl isobutyl ketone | 90.3 parts by mass |

Physical properties were measured by the above methods for an antireflection film produced by the above process using this coating composition, and the results are shown in Table 1 below.

### Comparative Example 3

### Example where Low-Molecular Antistatic Agent Free from Crosslinking Group in its Molecule is Used

A coating composition of Comparative Example 3 as a coating composition for antistatic hardcoat layer formation was prepared by mixing the following ingredients together.

| | |
|---|---|
| Pentaerythritol triacrylate (PETA) | 15.0 parts by mass |
| JP-518-O [tradename, manufactured by | 15.0 parts by mass |
| Johoku Chemical Corp.; alkyl chain | |
| phosphoric ester (belonging to | |
| low-molecular antistatic agent free from | |
| crosslinking group in its molecule)] | |
| Irgacure 184 (tradename, manufactured | 0.05 part by mass |
| by Ciba Specialty Chemicals, K.K.) | |
| Methyl isobutyl ketone | 68.5 parts by mass |

Physical properties were measured by the above methods for an antireflection film produced by the above process using this coating composition, and the results are shown in Table 1 below.

### Comparative Example 4

A coating composition of Comparative Example 4 as a coating composition for antistatic hardcoat layer formation was prepared by mixing the following ingredients together.

| | |
|---|---|
| U-601LPA60 (manufactured by | 30 parts by weight |
| Shin-Nakamura Chemical Co., Ltd.; | |
| Actinic radiation reactive antistatic agent | |
| Toluene | 70 parts by weight |

[Table 1]

TABLE 1

| | | | | | | | After high-temp./ | |
|---|---|---|---|---|---|---|---|---|
| | Surface | Minimum | Refractive | Interference | | | high-humidity test | |
| Examples | resistivity | reflectance, % | index | fringe | Adhesion | Haze | Haze | Surface resistivity |
| Example 1 | 10⁹ Ω/□ | 1.2 | 1.52 | ◯ | ◯ | 0.2 | 0.4 | 10⁹ Ω/□ |
| Example 2 | 10⁹ Ω/□ | 1.4 | 1.51 | ◯ | ◯ | 0.4 | 0.5 | 10⁹ Ω/□ |
| Example 3 | 10¹¹ Ω/□ | 1.2 | 1.51 | ◯ | ◯ | 0.4 | 0.5 | 10¹² Ω/□ |
| Comparative | 10¹⁴ Ω/□ | 1.1 | 1.5 | ◯ | ◯ | 0.2 | 0.3 | 10¹⁴ Ω/□ or more |
| Example 1 | or more | | | | | | | |
| Comparative | 10⁷ Ω/□ | 1.3 | 1.58 | X | ◯ | 0.8 | 0.9 | 10⁷ Ω/□ |
| Example 2 | | | | | | | | |
| Comparative | 10¹⁰ Ω/□ | 1.4 | 1.51 | ◯ | X | 0.3 | 3 | 10¹⁴ Ω/□ or more |
| Example 3 | | | | | | | | |
| Comparative | 10¹⁰ Ω/□ | 1.4 | 1.51 | ◯ | X | 0.4 | 4.1 | 10¹⁴ Ω/□ |
| Example 4 | | | | | | | | |

### (2) Re: Examples 4 to 6 and Comparative Examples 4 to 8

In the following Example 5 and Comparative Examples 5 to 8, an antireflection film having a layer construction of transparent base material film/antistatic layer/hardcoat layer/low-refractive index layer was prepared as follows.

An 80 μm-thick TAC film (triacetylcellulose film) was provided as a transparent base material film. The coating composition for antistatic layer formation described in Example 5 and Comparative Examples 4 to 6 was bar coated, and the coating was dried to remove the solvent. The dried coating was exposed to ultraviolet light with an ultraviolet irradiation apparatus (manufactured by Fusion UV Systems Japan K.K.) at an exposure of 20 mJ/cm² to cure the antistatic layer and thus to form an about 1 μm-thick antistatic layer.

The following coating composition for hardcoat layer formation was bar coated onto the laminate film having a layer construction of transparent base material film/antistatic layer. The coating was dried to remove the solvent. The dried coating was then exposed to ultraviolet light with an ultraviolet irradiation apparatus (manufactured by Fusion UV Systems Japan K.K.) at an exposure of 100 mJ/cm² to cure the hardcoat layer and thus to prepare a laminate film having a layer construction of transparent base material film/antistatic layer/about 5 μm-thick hardcoat layer.

The composition for low-refractive index layer formation described in the column of “(1) Re: Examples 1 to 4 and Comparative Examples 1 to 3” was bar coated onto the laminate film having a layer construction of transparent base material film/antistatic layer/hardcoat layer. The coating was then dried to remove the solvent. The dried coating was exposed to ultraviolet light with an ultraviolet irradiation device (manufactured by Fusion UV Systems Japan K.K.) at an exposure of 260 mJ/cm² to cure the coating film and thus to prepare a laminate (antireflection film) having a layer construction of transparent base material film/antistatic layer/hardcoat layer/about 100 nm-thick low-refractive index layer.

For the antireflection films prepared in Example 5 and Comparative Examples 4 to 6, the surface resistivity (Ω/□), the minimum reflectance, the refractive index, the occurrence of interference fringes, and the adhesion of the coating film were measured in the same manner as described in the column of “(1) Re: Examples 1 to 4 and Comparative Examples 1 to 3.”

Formulation of Coating Composition for Hardcoat Layer Formation

The following ingredients for the composition were mixed together to prepare a coating composition for hardcoat layer formation.

| | |
|---|---|
| Pentaerythritol acrylate (PETA) | 30.0 parts by mass |
| Irgacure 184 (manufactured by Ciba | 1.5 parts by mass |
| Specialty Chemicals, K.K.) | |
| Methyl isobutyl ketone | 73.5 parts by mass |
| Organic beads having average particle | 0.15 part by mass |
| diameter of 5 μm surface treated | |
| with gold and nickel (manufactured by | |
| The Nippon Chemical Industrial Co., | |
| Ltd., Bright 20GNR-4.6EH: tradename) | |

### Example 4

The coating solution of Example 1 was coated on the above layer construction.

### Example 5

The coating solution of Example 2 was coated on the above layer construction.

### Example 6

The coating solution of Example 3 was coated on the above layer construction.

For antireflection films produced by the above production process using the coating composition, the properties were measured by the above methods. The results are shown in Table 2 below.

### Comparative Example 4

Example Where no Antistatic Layer is Formed

An antireflection film of Comparative Example 4 was prepared in the same manner as in Example 5, except that no antistatic layer was formed. For the antireflection film of Comparative Example 4, the properties were measured by the above methods. The results are shown in Table 2 below.

### Comparative Example 5

### Example Where Metal Oxide is Used as Antistatic Agent

A coating composition of Comparative Example 5 as a coating composition for antistatic layer formation was prepared by mixing the following ingredients together.

| | |
|---|---|
| Tin indium oxide dispersion | 33.3 parts by mass |
| (solid content 30%, methyl isobutyl | |
| ketone solution) | |
| Pentaerythritol triacrylate (PETA) | 10.0 parts by mass |
| Irgacure 184 (tradename, manufactured | 0.05 part by mass |
| by Ciba Specialty Chemicals, K.K.) | |
| Methyl isobutyl ketone | 90.3 parts by mass |

Physical properties were measured by the above methods for an antireflection film produced by the above process using this coating composition, and the results are shown in Table 2 below.

### Comparative Example 6

### Example Where Low-Molecular Antistatic Agent free From Crosslinking Group in its Molecule is Used

A coating composition of Comparative Example 6 as a coating composition for antistatic layer formation was prepared by mixing the following ingredients together.

| | |
|---|---|
| Pentaerythritol triacrylate (PETA) | 15.0 parts by mass |
| JP-518-O [tradename, manufactured by | 15.0 parts by mass |
| Johoku Chemical Corp.; alkyl chain | |
| phosphoric ester (belonging to | |
| low-molecular antistatic agent free from | |
| crosslinking group in its molecule)] | |
| Irgacure 184 (tradename, manufactured | 0.05 part by mass |
| by Ciba Specialty Chemicals, K.K.) | |
| Methyl isobutyl ketone | 68.5 parts by mass |

Physical properties were measured by the above methods for an antireflection film produced by the above process using this coating composition, and the results are shown in Table 2 below.

[Table 2]

TABLE 2

| | | | | | | | After high-temp./ | |
|---|---|---|---|---|---|---|---|---|
| | Surface | Minimum | Refractive | Interference | | | high-humidity test | |
| Examples | resistivity | reflectance, % | index | fringe | Adhesion | Haze | Haze | Surface resistivity |
| Example 4 | 10¹⁰ Ω/□ | 1.2 | 1.52 | ◯ | ◯ | 0.2 | 0.3 | 10¹⁰ Ω/□ |
| Example 5 | 10¹⁰ Ω/□ | 1.3 | 1.51 | ◯ | ◯ | 0.4 | 0.5 | 10¹⁰ Ω/□ |
| Example 6 | 10¹⁴ Ω/□ | 1.2 | 1.51 | ◯ | ◯ | 0.2 | 0.5 | 10¹⁴ Ω/□ |
| Comparative | 10¹⁴ Ω/□ | 1.2 | 1.5 | ◯ | ◯ | 0.2 | 0.3 | 10¹⁴ Ω/□ or more |
| Example 5 | or more | | | | | | | |
| Comparative | 10¹⁴ Ω/□ | 1.3 | 1.58 | X | ◯ | 0.8 | 0.9 | 10¹⁴ Ω/□ or more |
| Example 6 | or more | | | | | | | |
| Comparative | 10¹⁰ Ω/□ | 1.4 | 1.52 | ◯ | X | 0.3 | 2.5 | 10¹⁴ Ω/□ or more |
| Example 7 | | | | | | | | |
| Comparative | 10¹³ Ω/□ | 1.4 | 1.51 | ◯ | X | 0.3 | 4.6 | 10¹³ Ω/□ |
| Example 8 | | | | | | | | |

### INDUSTRIAL APPLICABILITY

The antireflection film according to the present invention can prevent the adherence of dust, can well prevent the occurrence of interference fringes and has excellent coating film adhesion and thus is suitable as an antireflection film for use on the surface of optical articles, for example, displays such as liquid crystal displays and plasma displays.

1. An antireflection film comprising:
a transparent base material film and, provided on the transparent base material film in the following order,
an antistatic hardcoat layer comprising an antistatic agent and an ionizing radiation curing resin, the antistatic agent being selected from polymeric antistatic agents, crosslinking group-containing low-molecular antistatic agents, and electrically conductive antistatic agents, and
a low-refractive index layer having a lower refractive index than an underlying layer in direct contact with the low-refractive index layer, wherein
the absolute value of the difference in refractive index between the transparent base material film and the antistatic hardcoat layer is not more than 0.03, whereby the occurrence of interference fringes is prevented.

2. An antireflection film comprising:
a transparent base material film and, provided on the transparent base material film in the following order,
an antistatic layer comprising an antistatic agent and a binder agent, the antistatic agent being selected from polymeric antistatic agents, crosslinking group-containing low-molecular antistatic agents, and electrically conductive antistatic agents,
a hardcoat layer comprising an ionizing radiation curing resin, and
a low-refractive index layer having a lower refractive index than an underlying layer in direct contact with the low-refractive index layer, wherein
both the difference in refractive index between the transparent base material film and the antistatic hardcoat layer, and the difference in refractive index between the antistatic layer and the hardocat layer being ±0.03, whereby the occurrence of interference fringes is prevented.

3. The antireflection film according to claim 1, wherein the polymeric antistatic agent is a molecule crosslinking group-containing compound.

4. The antireflection film according to claim 1, wherein the polymeric antistatic agent is a quaternary ammonium cation-containing structure.

5. The antireflection film according to claim 1, wherein the difference in haze between before and after the antireflection film is placed in an environment of temperature 80° C. and humidity 90% for 500 hr is not more than 3.
